(19) United States
(12) Patent Application Publication
(10) Pub. No.: US 2006/0065085 A1
(43) Pub. Date: Mar. 30, 2006

(54) Multi element tool designs for modifying surface characteristics of substrates

(75) Inventor: Eugene George Olczak, Pittsford, NY (US)

Correspondence Address: Andrew J. Caruso;General Electric Global Research, Docket Room K1-4A59, One Research Circle, Niskayuna, NY, 12309, US

(73) Assignee: General Electric Company, Schenectady, NY (US)

(21) Appl. No.: 11/219,461

(22) Filed: Sep. 1, 2005

Related U.S. Application Data
(60) Provisional application No. 60/614,335, filed on Sep. 29, 2004.

(51) Int. Cl. B23B 3/00

(52) U.S. Cl. 82/118

(57) ABSTRACT

There is provided an assembly for modifying a surface of a workpiece, where the assembly is responsive to a plurality of control signals. The assembly includes a plurality of tools and a plurality of displacement mechanisms. The plurality of tools are configured to modify the surface of the workpiece. The plurality of displacement mechanisms are each arranged to displace a respective one of the tools along a substantially same path on the workpiece in response to at least one of the control signals.

### RELATED APPLICATIONS

This application claims the benefit of U.S. Provisional Application No. 60/614,335 filed Sep. 29, 2004, which is incorporated by reference herein in its entirety.

### FIELD OF THE INVENTION

This invention is related generally to a tool apparatus, and tool control methods.

### BACKGROUND OF THE INVENTION

Tools for modifying structure in the surface of a workpiece are known. For example computer numerically controlled (CNC) turning or milling machines can machine grooves in a workpiece by controlling the displacement of a cutting tool relative to the workpiece. Such systems use hard tools such as diamond crystals. Other tools use lasers for modified a substrate through ablation, agglomeration or other processes. Still other tools use electric discharge machining to modify a substrate or piezo elements to apply ink or other materials to a substrate surface.

In a typical application, a workpiece is mounted on or bonded to a surface of a drum. The drum is controlled to rotate as the cutting tool is displaced both into and along the workpiece.

Some CNC turning or milling machines include a pair of relatively massive slides that move along orthogonal axes to displace the cutting tool along and into the workpiece. In the case of applications with a rotating drum support, one of the directions that the cutting tool is displaced is along the rotational axis of the drum, and another direction is into the workpiece.

Other CNC turning or milling machines include a fast tool servo (FTS) with a piezoelectric actuator, for example, to displace the cutting tool relative to the work piece. The piezoelectric actuator displaces the cutting tool based upon control signals received, and the cutting tool is displaced relative to the workpiece, either into the workpiece, or laterally relative to the surface of the workpiece.

### SUMMARY OF THE INVENTION

In accordance with one embodiment of the present invention, there is provided an assembly for modifying a surface of a workpiece, said assembly being responsive to a plurality of control signals, said assembly comprising: a plurality of tools configured to modify the surface of the workpiece; at least one first displacement mechanism arranged to displace the plurality of tools relative to the workpiece in a coordinate system in response to at least one of the control signals; and a plurality of second displacement mechanisms supported by the first displacement mechanism, said second displacement mechanisms being configured to provide independent displacement of each of the plurality of tools relative to the workpiece in response to at least one of the control signals.

In accordance with another embodiment of the present invention, there is provided an assembly for modifying a surface of a workpiece, said assembly being responsive to a plurality of control signals. The assembly comprises: a plurality of tools configured to modify the surface of the workpiece; and a plurality of displacement mechanisms, each displacement mechanism arranged to displace a respective one of the tools along a substantially same path on the workpiece in response to at least one of the control signals.

In accordance with another embodiment of the present invention, there is provided an assembly for modifying the surface of a workpiece, said assembly being responsive to a plurality of control signals. The assembly comprises: a first group of tools configured to modify the surface of the workpiece; a second group of tools configured to modify the surface of the workpiece; a first group of displacement mechanisms, each displacement mechanism of the first group arranged to displace a respective one of the first group of tools along a substantially same first path on the workpiece in response to at least one of the control signals; and a second group of displacement mechanisms, each displacement mechanism of the second group arranged to displace a respective one of the second group of tools along a substantially same second path on the workpiece in response to at least one of the control signals.

### BRIEF DESCRIPTION OF THE DRAWINGS

FIG. 1 is a side view schematic of a vertical drum workpiece and an assembly according to an embodiment of the invention.

FIG. 2 is a front view schematic of the vertical drum workpiece and assembly of FIG. 1.

FIG. 3 is a side view schematic of a horizontal drum workpiece and an assembly according to another embodiment of the invention.

FIG. 4 is a top view schematic of the horizontal drum workpiece and assembly of FIG. 3.

FIG. 5 is a schematic of a drum workpiece and an assembly with two groups according to an embodiment of the invention.

FIG. 6 is a detailed schematic of a single secondary tool displacement mechanism used in an assembly according to an embodiment of the invention.

FIG. 7 is a schematic of a second displacement mechanism of the single secondary tool displacement mechanism of FIG. 6 with two piezoelectric actuators and amplifiers.

FIG. 8 is a schematic illustrating digital to analog converters and a single switch of the single secondary tool displacement mechanism of FIG. 6.

FIG. 9 is a schematic illustrating an assembly including a plurality of second displacement mechanisms and tools according to an embodiment of the invention.

### DETAILED DESCRIPTION OF THE PREFERRED EMBODIMENTS

Reference will now be made in detail to presently preferred embodiments of the present invention. Wherever possible, the same reference numbers will be used throughout the drawings to refer to the same or like parts.

The present invention is applicable to create deterministic or randomized structures or features on a workpiece surface, such as a master surface.

The present inventor has realized that there is a need to implement an assembly of tools modifying a surface of a workpiece, where the tool displacement mechanisms of the tools are such that individual displacements due to each of the displacement mechanisms are synchronized with each other. The synchronization may be based on the same set of control signals, for example, that are typically sent to control a single displacement mechanism.

Such synchronization allows for a machining tool system where multiple passes may be made over the same tool path, where the position of the tool lateral displacement is substantially identical for each of the passes. Thus, the features formed in a workpiece with the tool may be formed with good precision. The tool may be, for example, a cutting tool that acts to cut a groove into the workpiece. In general, the displacement provided may be angular, linear, or a combination thereof.

The plurality of tools increases processing speed and reduces tool usage compared to using a single tool. Further, tool wear per workpiece for each individual tool is reduced, because multiple tools are used to modify the workpiece. Using multiple synchronized tools to pass over the same path not only reduces the wear for each tool, but minimizes the pass to pass drift, such as thermal drift, that is encountered for single tool making multiple passes over substantially the same tool path.

When two or more of the tools are controlled to pass over substantially the same path these tools are considered as belonging to a group. Each tool in a group may pass sequentially over the same path one or more times. Additional there may be more than one group in the assembly.

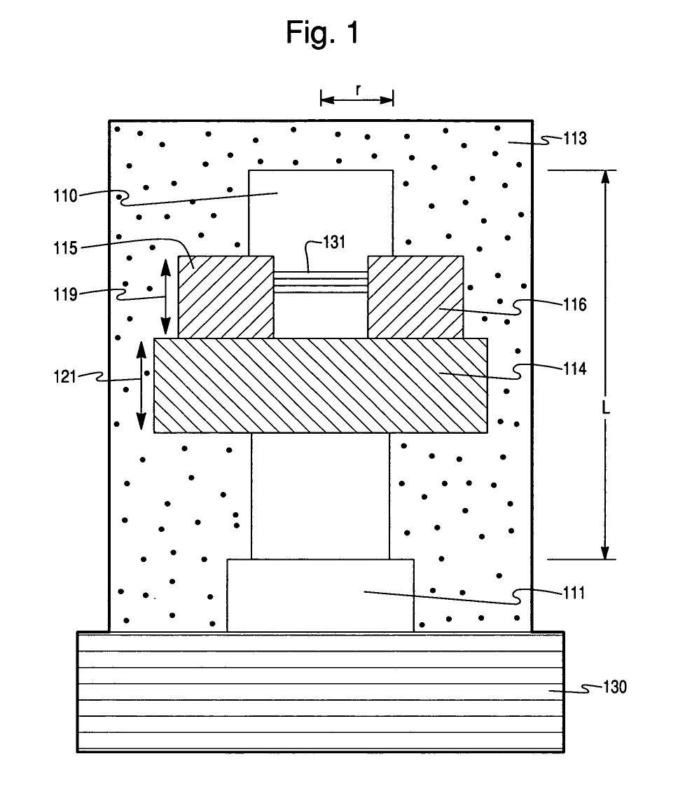

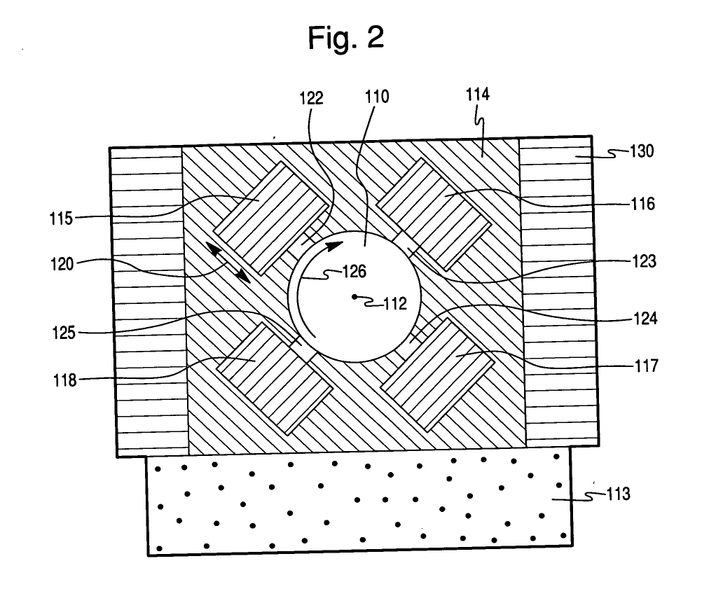

FIGS. 1 and 2 show a drum workpiece illustrating the assembly of tools according to an embodiment of the invention. The drum 110 has a length L and a radius r. The drum 110 can be rotated about its axis 112 along an angular direction 0, (126) by a spindle 111 on a spindle support 130. Individual secondary tool displacement mechanisms 115, 116, 117 and 118 may be moved axially along the axis 112 along the z axis, by a linear slide 113 which supports a shelf 114 on which the secondary tools are placed. In this case the linear slide 113, shelf 114, and the spindle 111 comprise the first displacement mechanism. The secondary tool displacement mechanisms each provide motion in the radial direction 120 and axial direction (along the z-axis), 119 for each tool, 122, 123, 124 and 125. The slide motion 121 may be along the z-axis. The tools, 122, 123, 124 and 125, are controlled by the displacement mechanisms to follow along a path or paths 131.

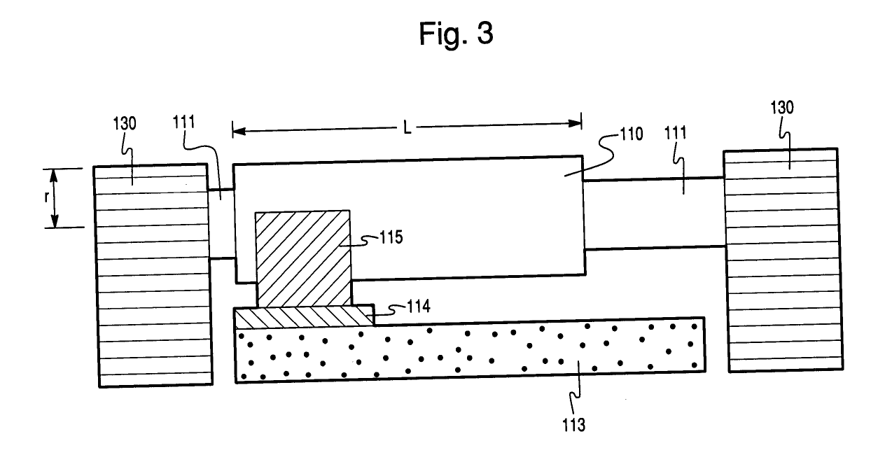

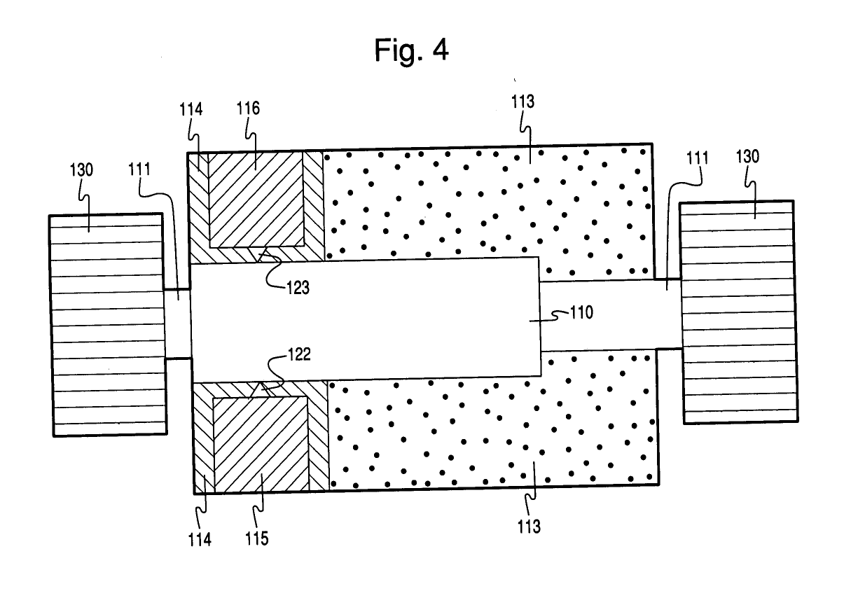

FIGS. 3 and 4 show a drum workpiece illustrating the assembly of tools according to another embodiment of the invention, where like reference numerals indicate the same components. The embodiment of FIGS. 1 and 2 illustrate an assembly where the drum axis is vertical, while the embodiment of FIGS. 3 and 4 illustrate an assembly where the drum axis is horizontal.

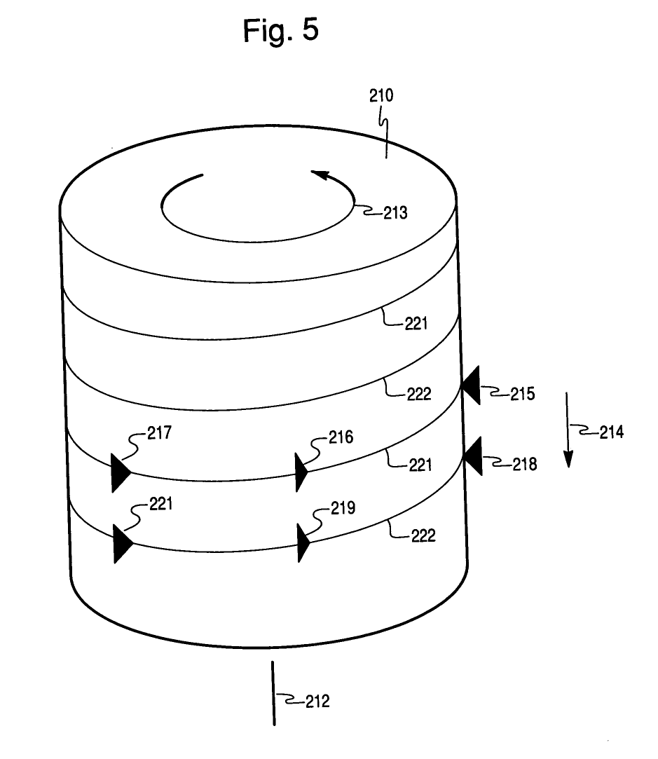

FIG. 5 shows a drum workpiece illustrating the assembly of tools according to an embodiment of the invention using a helical path pattern and two tool groups. The drum 210 has a length L and a radius r. The drum 210 can be rotated about its axis 212 along an angular direction 213 and displaced in an axial direction 214 by a first displacement mechanism (not shown in FIG. 5) relative to the secondary tool displacement mechanisms, 215, 216, 217, 218, 219 and 220. Tools 215, 216, and 217 belonging to a first group move along a first nominally helical path 221 on the drum surface 224 and tools 218, 219 and 220 belonging to a second group move along a second nominally helical path 222 on the drum surface 224. The nominal path followed by the tools is not limited to a helical path, but may be annular or linear, for example, or some other path. Further, the actual path followed by the tools may in general be other than the nominal path. In this regard, the tools in a group may be controlled to be displaced laterally relative to the nominal path, for example.

In some cases each of these secondary tool displacement mechanisms may hold a cutting tool. Additionally, each subsequent secondary tool displacement mechanisms in each group may be offset radially inward relative to the drum. In this way progressively more material is removed from the drum surface by each tool in each group.

In other cases each of these secondary tool displacement mechanisms may hold a material deposition tool. In this case, each subsequent secondary tool displacement mechanisms in each group may be offset radially outward relative to the drum. In this way progressively more material is added to the drum surface by each tool in each group.

In some applications it is preferable that the secondary displacement mechanism is capable of a higher frequency response than the first displacement mechanism. Because the higher frequency motion of a second displacement mechanism is synchronized with a lower frequency motion, surface structures with multiple scales may be formed with traditional control signals at a much higher speed. The microstructures formed can thus have a greater range of change.

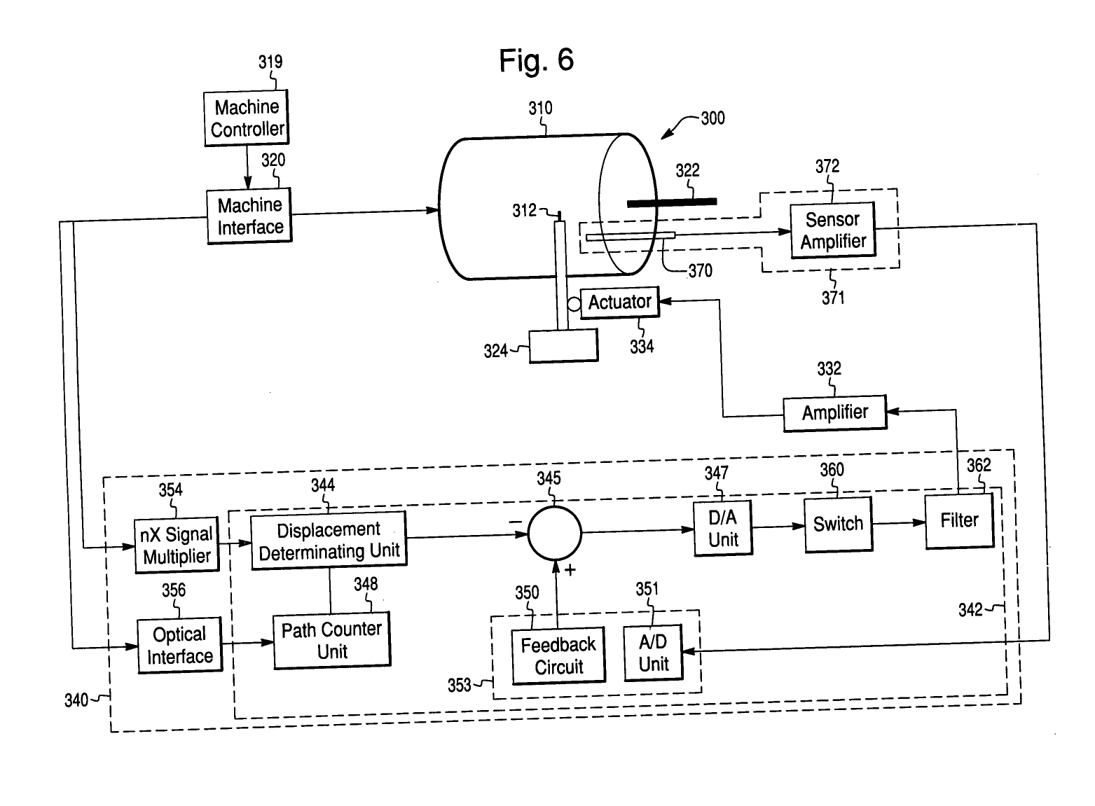

FIG. 6 is a detailed schematic of a single secondary tool displacement mechanism along with a first displacement mechanism (spindle drive 322 and slide 324) used as part of an assembly according an embodiment of the invention. The single secondary tool displacement mechanism is isolated in this example for simplicity in the following discussion. The assembly in the full embodiment of the invention may comprise a plurality of secondary tool displacement mechanisms.

The assembly 300 includes a workpiece 310. The workpiece 310 may comprise a rotating drum as shown in FIG. 6. Alternatively, the workpiece support may comprise a substantially planar surface or may have some other geometry.

The assembly 300 includes a tool 312 that is configured to be displaced toward or away from the surface of the workpiece 310, and thus toward and into any workpiece or away from any workpiece. The tool 312 may also be displaced laterally relative to the surface of the workpiece 310. In the case the workpiece 310 is a drum, the tool may be displaced along the axis of the drum, in addition to laterally perpendicular to the axis.

The assembly 300 has a first displacement mechanism arranged to displace the tool 312 relative to the workpiece. The first displacement mechanism displaces the tool 312 relative to the workpiece in response to control signals. The control signals originating from a machine controller 319 come through a machine interface 320, such as a lathe interface in the case that the workpiece 310 is a drum. The control signals may be digital signals from a machine encoder or resolver (not shown) of the machine controller 319, and may be in G code and M code, for example, as is known for machine encoders. The control signals may be in the form of TTL square wave pulses or analog sine waves.

The first displacement mechanism may comprise a spindle drive 322 and a slide 324, for example. The spindle drive 322 drives the workpiece 310 about its axis in a first direction along an angular displacement 0 (See FIG. 1 illustrating angular displacement 0). The slide 324 displaces the tool 312 along the axis of the workpiece 310. Both the spindle drive 322 and the slide 324 movement are controlled based on the control signals from the machine controller 319. The first displacement mechanism may be part of a CNC lathe system, for example, such as a CNC lathe system produced by Precitech, Moore Nanotech Systems or Cranefield, for example.

The assembly 300 has a second displacement mechanism arranged to displace the tool 312 relative to the workpiece. The second displacement mechanism displaces the tool 312 relative to the workpiece in response to the control signals originating from the machine interface 320. The control signals may be from the same set as those used to control the first displacement mechanism.

The second displacement mechanism displaces the tool 312 relative to the workpiece in a second set of coordinates. For example, for a workpiece 310 that is a drum, the second set of coordinates may include the direction along the axis of the drum (the z axis), the direction radially away or toward the axis (the y axis), and/or the direction perpendicular to the y axis and the z axis (the x axis) (see FIG. 1).

Preferably the second displacement mechanism is capable of a higher frequency response than the first displacement mechanism. Because the higher frequency motion of a second displacement mechanism is synchronized with a lower frequency motion, surface structures with multiple scales may be formed with traditional control signals at a much higher speed. The microstructures formed can thus have a greater range of change.

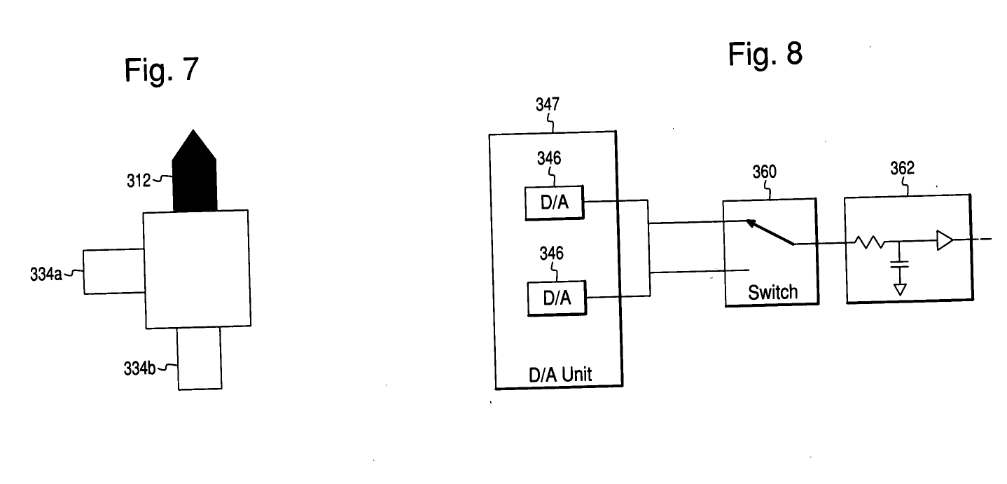

The second displacement mechanism may comprise an FTS, such as at least one piezoelectric amplifier 332 and piezoelectric actuator 334, for example. The at least one piezoelectric actuator 334 may include a first piezoelectric actuator 334a configured to displace the cutting tool in a first direction, and a second piezoelectric actuator 334b (See FIG. 7) configured to displace the cutting tool in a second direction different from the first direction. The first and second direction may orthogonal to each other and may be along the y-axis (into or out of the work piece), and x-axis (along the surface of the workpiece, but perpendicular to the drum axis), for example. Alternatively the directions need not be orthogonal.

The assembly 300 may also include a controller 340 configured to receive the control signals and synchronize the displacement of the cutting tool 312 due to the first displacement mechanism with the displacement of the cutting tool due to the second displacement mechanism.

The controller 340 includes an electronic control unit 342 including a displacement determination unit 344, digital to analog unit 347, which may comprise a plurality of digital to analog converters 346 (See FIG. 8), a path counter unit 348, and a feedback control unit 350. Alternatively, one or more of the displacement determination unit 344, digital to analog unit 347, path counter unit 348, and feedback control unit 350 may be separate from the electronic control unit 342. The electronic control unit 342 may be a dSPACE system such as the DS1103 PPC Controller Board provided by dSPACE, or a digital signal processor (DSP) such as ChicoPlus or TORO from Innovative Integration, for example. The present invention is not limited to a particular electronic control unit.

The controller 340 may optionally include an nX signal multiplier/divider 354, such as an nX encoder multiplier/divider, that receives position control signals from the machine encoder of the machine interface 320, and functions to multiply the frequency of the control signals by n times in the second direction, and pass the multiplied frequency control signals to the displacement determination unit 344. In general, n is greater than or less than 1. When n is greater than 1, the nX encoder multiplier/divider functions to increase the frequency of the control signals where the increased frequency is n times the input frequency. In this case the nX signal multiplier/divider increases the resolution of the number of points in the second direction processed by the displacement determination unit 344. On the other hand, when n is less than 1, the nX signal multiplier/divider functions to decrease the frequency of the control signals where the decreased frequency is again n times the input frequency. In this case the nX encoder multiplier/divider decreases the resolution of the number of points in the second direction processed by the displacement determination unit 344. n may be an integer greater than or equal to 2, for example, such as 4, for example. n need not be an integer, however, and thus the nX encoder multiplier/divider may provide fractional rate conversion.

An example of the functioning of the nX signal multiplier/divider 354 is as follows. Assume that the nX signal multiplier/divider 354 is a 4× signal multiplier, and the position signals correspond to 5000 points circumferentially along the θ direction of the drum. In other words, the resolution in the θ direction for the first displacement mechanism is 5000 points. The nX signal multiplier 354 acts to increase frequency of the position signal to 4 times the input frequency. This increase in frequency increases the number of points circumferentially along the drum to 20000 through interpolation, for example, to thereby increase the resolution of points acted on by the displacement determination unit 344, and thus 20,000 points for the second displacement direction. The increased frequency signal is then fed to the displacement determination unit 344, and also acts to trigger at least one switch 360 as discussed further below.

Selecting n for the nX signal multiplier/divider 354 provides some degree of tunability to the assembly 300. For a lower n, the resolution is decreased, but the machining speed of the assembly 300 is increased since fewer points need be processed for a particular path along the workpiece. On the other hand, if a higher resolution, and therefore fidelity, is desired, a larger n may be chosen at the expense of the machining speed.

The controller 340 may optionally include an optical interface 356 that provides electrical isolation and receives the trigger signals from the machine interface 320, passes the trigger signals to the path counter unit 348. The trigger signals of the control signals from machine interface 320 indicate the triggering of the first displacement mechanism.

The path counter unit 348 is configured to determine the current path that the cutting tool 312 is on. The path counter unit 348 performs this function based on the control signals from the machine interface 320, and specifically based on the trigger signals of the control signals. In the case that the workpiece support 310 is a rotating drum, the paths will correspond to rings that are to be cut into the workpiece, and the path counter unit 348 keeps track of the ring number.

The displacement determination unit 344 determines a target displacement of the cutting tool in the second set of coordinates and provides target displacement digital signals based on the determined target displacement. The displacement determination unit 344 performs this determination based on the multiplied frequency control signals from the nX signal multiplier/divider 354 and the current path determined from the path counter unit 348. Thus, the path counter unit 348 informs the displacement determination unit 344 of the current path. If it is not desired to increase the frequency of the control signals, for example so that the machining speed is higher, the displacement determination unit 344 may receive control signals without increasing their frequency, and the nX signal multiplier/divider 354 may be omitted.

The increased frequency control signals (or just the control signals if increased resolution is not desired) provides information about a position along one or more of the coordinates of the first displacement mechanism but with increased (or decreased) resolution. As an example, assume the workpiece 310 is a rotating drum with the first displacement mechanism providing displacement along the z-axis (rotational axis) and in the θ direction, and the machining tool 300 includes a 4× signal multiplier/divider. Also assume the number of points in the θ direction around the drum is 5000 for the first displacement mechanism, and the control signal indicates that the 1000^{th} point (about one-fifth of the way around the drum from the first point) along the θ direction is the current point for the first displacement mechanism. The 4× signal multiplier/divider 354 provides increased frequency signals corresponding to 4 points in the second set of coordinates (for the second displacement mechanism) for every point in the first set of coordinates (for the first displacement mechanism), and thus provides for 4 points around the 1000^{th} point. The displacement determination unit 344 uses the multiplied frequency signal, which is indicative of one of these 4 points indicating position around the drum, and the current path (or ring), and determines a target displacement of tool in the second set of coordinates corresponding to the second displacement mechanism.

For the sake of illustration, assume that the current point corresponds to a current angle θ_{cur} and that the current path is p_{cur}. Also assume that the second set of coordinates are given by y₂ and z₂. The displacement determination unit 344 will determine the target displacement in the second set of coordinates as y₂=f_{y}2(θ_{cur}, p_{cur}), and z₂=fz2(θ_{cur}, p_{cur}), where fy2(θ_{cur}, p_{cur}) and fz2(θ_{cur}, p_{cur}) are functions of θ_{cur} and p_{cur}. In other words the target displacement in the second set of coordinates is a function of the displacement in the first set of coordinates as indicated by the control signals.

The displacement determination unit 344 provides target displacement digital signals based on the determined target displacement. The plurality of digital to analog converters 346 are configured to receive respective of the target displacement digital signals from the displacement determination unit 344 and convert the target displacement digital signals to target displacement analog signals.

The displacement determination unit 344 may determine the target displacement by calculating the displacement on the fly as the multiplied frequency control signals are received from the nX signal multiplier/divider 354. In this case, the target displacement determination unit 344 may include a processor with appropriate software or firmware to calculate the target displacement as desired. Alternative, the target displacement may be pre-calculated and the pre-calculated values of the target displacement may be received from external to the displacement determination unit 344. The target displacement may be pre-calculated and stored in a memory external to the displacement determination unit 344, and streamed into the displacement determination unit 344 as the multiplied frequency control signals are received.

The assembly 300 may optionally include at least one switch 360 configured to alternate which digital to analog converter 346 releases the analog signals corresponding to a respective of the target displacement digital signals received from the displacement determination unit 344. The at least one switch 360 may comprise a gate, for example. The at least one switch 360 alternates which digital to analog converter 346 releases a respective of the target displacement analog signals based upon the control signals, for example, based upon the multiplied frequency control signal from the nX signal multiplier/divider 354. The target displacement analog signals are filtered by filter 362 and passed to piezoelectric amplifier 332.

The assembly 300 may also include a sensor unit 371, including a position sensor 370 and a sensor amplifier 372, and a feed back control unit 353, including an analog to digital unit 351 and feed back control circuit 350, to adjust the target displacement control signals as necessary. The position sensor unit 371 is arranged to detect the position of the cutting tool 312, and to provide a position signal indicative of the detected position of the cutting tool 312 to the feedback control unit 353. The feedback control unit 353 is arranged to receive the position signal, amplified by the sensor amplifier 372 as desired, and adjust the target displacement digitals signals based on the position signal. The analog to digital unit 351 comprises one or more analog to digital converters to convert the position signal from the sensor amplifier 372 to digital and provide a digital position signal to the feedback control circuit 350. The feedback control circuit 350 provides a feedback signal to correct the target displacement signal at the combiner 345. The feedback control helps compensate for hysteretic and creep effects of the piezoelectric materials of the piezoelectric actuators, and thus enhances correct tool movement.

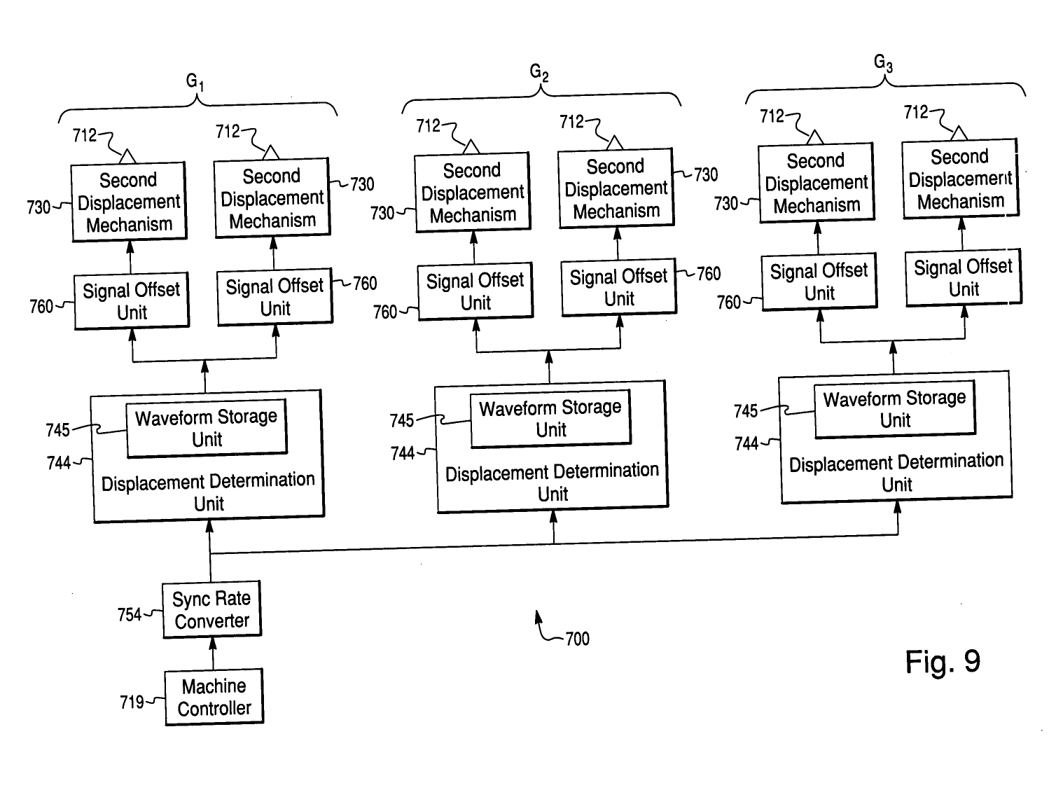

FIG. 9 is a schematic of an assembly 700 including a plurality of second displacement mechanisms 730 and respective tools 712. The second displacement mechanisms 730 and respective tools 712 may be arranged in groups Gᵢ, such as G₁, G₂ and G₃ shown for the three groups in FIG. 9. Of course the number of groups may be other than three, and may in general be one or more. The second displacement mechanisms 730 may include actuators and amplifiers in a similar fashion to the actuator 334 and amplifier 332 shown in FIG. 6. The assembly 700 includes a machine controller 719, such as a CNC machine controller, for example. The machine controller 719 provides control signals, such as in G code or M code, for example, for controlling the first displacement mechanism (not shown in FIG. 9), as well as for controlling the second displacement mechanisms 730.

The control signals are provided to a sync rate converter 754 (such as the nX encoder multiplier/divider 354 of FIG. 6), that receives the control signals from the machine controller 719, and functions to multiply the frequency of the control signals received by a number n, where n is greater than or less than 1, and pass the multiplied control signals to a number of displacement determination units 744. Each of the displacement determination units 744 may correspond to a respective of the groups, G₁, G₂ and G₃, shown in FIG. 9.

The displacement determination units 744, in a similar fashion to the displacement determination unit 344 of FIG. 6, determines a target displacement of the tool in the second set of coordinates of the second displacement mechanism 730 and provides target displacement signals based on the determined target displacement. If it is not desired to increase the frequency of the control signals, for example so that the machining speed is higher, the displacement determination unit 744 may receive control signals without increasing their frequency, and the sync rate converter 754 may be omitted.

The displacement determination units 744 may each include a waveform storage unit 745 that stores a waveform for the target displacement. The waveform corresponds to the target displacement in the second set of coordinates as a function of first set of coordinates (of the first displacement mechanism) as indicated by the control signals. Alternatively to the waveform storage unit 745, the displacement determination unit 744 may calculate the target displacement on the fly. Each displacement determination unit 744 provides target displacement signals to one or more signal offset units 760 that produce a temporal offset to the signals, and gain if necessary, to the second displacement mechanisms 730.

Each of the signal offset units 760 provides a temporal offset and gain to the target displacement signals received, where the offset and gain are appropriate to the signal offset unit's 760 respective displacement mechanism. The signal offset units 760 may also compensate for differences in frequency response of each displacement mechanism, using open loop or closed loop methods. The particular offsets will in general depend upon the arrangement of the tools relative to the workpiece, but will be such that all the tools 712 in a group traverse substantially the same path on the workpiece. In the case where there is more than one second displacement mechanism 730 in a group the control signals provided to the second displacement mechanism for each signal in a group may be essentially identical except for the temporal offset.

As an example, the workpiece may be a drum with four tools 712 and displacement mechanisms 730 per group, with the four tools 712 in each group arranged sequentially around the drum progressively offset by 90° (See FIG. 2). In this case the temporal offset should be such that the difference in temporal offset between a first tool in a group and a second tool to traverse substantially the path traversed by the first tool is equal to the time that the drum takes to rotate 90°. Progressively, the third tool and fourth tool to traverse the path will be temporally offset from the first tool by a time the drum takes to rotate 180° and 270°, respectively. In this way, the paths traversed by each of the tools in a group are substantially identical.

The signal offset units 760 may also provide a gain to the target displacement signals as appropriate. The gain provided may be different for each of the tools in a group, as necessary, to account for any different responses of the tools 712.

The machine controller 719, sync rate converter 754, displacement determination unit 744, waveform storage unit 745, and signal offset unit 760 may all be part of the same controller, or may be separated into different components. For example, if a DSP controller such as the Toro DSP is used, the functions of the displacement determination unit 744, waveform storage unit 745, and signal offset unit 760 may be incorporated into a single controller. As another alternative, the functions of the displacement determination unit 744, waveform storage unit 745, and signal offset unit 760 may be performed by a single component, such as the Edirol FA-101 Audio Capture Interface by Edirol Corporation, controlled with appropriate software such as SONAR software by Twelve Note Systems, Inc. In this case, an external sync rate converter and machine controller would be used. If a motion controller such as the PMAC (Programmable Multi Axis Controller) PC/104 by Delta Tau Data Systems, or a PC-104 motion controller by Galil Motion Control, is employed, the functions of all of the machine controller 719, sync rate converter 754, displacement determination unit 744, waveform storage unit 745, and signal offset unit 760 may all be performed by the controller.

In general, as can be seen, the functions of the machine controller 719, sync rate converter 754, displacement determination unit 744, waveform storage unit 745, and signal offset unit 760 may be performed by various combinations of hardware and software. Further, in general, the signals passed between the components may be analog or digital or a combination of analog and digital.

Further the waveform storage units 745 need not be separate storage units, but may be a single storage unit.

The assembly 700 may also include a position sensor and feedback control unit with feedback control circuit (not shown in FIG. 9) in a similar fashion to the position sensor unit 371, feed back control unit 353 and feedback control circuit 350 shown in FIG. 6. The feedback control unit may be part of the controller comprising the functions of the displacement determination unit 744, waveform storage unit 745, and signal offset unit 760. Alternatively, feedback control unit may be part of the machine controller 719, for example.

The individual tools used in the assembly may be hard tools such as single crystal diamonds or diamond coated tools, laser engraving tools, electrical discharge tools, high speed milling tools, fly cutting tools, material deposition tools or any other tools or combination of tools. This includes those that modify a substrate through ablation, agglomeration, phase change or those that use piezo elements to apply ink or other materials to a substrate.

The nominal tool paths may be linear, circular or annular, helical or any other tool path. Variations on the nominal paths may also be used including random variations or deterministic variations or any combination thereof. These variation may be applied to the first displacement mechanism, the second displacement mechanisms or any combination thereof. Further, while many of the embodiments described above illustrate tools groups so that there are more than one tool in each group, the tools may be grouped so that one or more of the groups have only one tool.

The present invention is applicable to a number of different applications. For example, microstructure may be machined in applications including diffusers, solar cell panels, reflectors, brightness enhancement films and heat/mass transfer control surfaces. For example, for thin-film solar cell applications, textured (by machining) TCO/glass/metal substrates, which provide light trapping may be formed. Angle selective specular reflectors may also be formed.

The particular first and second set of coordinates will depend on the particular application. The structures formed may have variation in one or more of amplitude, phase, period and frequency.

In embodiments of the present invention, because the high frequency motion of a second displacement mechanism, such as an FTS, is synchronized with a lower frequency motion, surface structures with multiple scales may be formed with traditional control signals at a much higher speed. The microstructures formed have a greater range of change. Machining these structures in multiple repeatable passes produces a superior surface finish.

While the invention has been described in detail and with reference to specific embodiments thereof, it will be apparent to one skilled in the art that various changes and modifications can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. An assembly for modifying a surface of a workpiece, said assembly being responsive to a plurality of control signals, said assembly comprising:
a plurality of tools configured to modify the surface of the workpiece;
at least one first displacement mechanism arranged to displace the plurality of tools relative to the workpiece in a coordinate system in response to at least one of the control signals;
a plurality of second displacement mechanisms supported by the first displacement mechanism, said second displacement mechanisms being configured to provide independent displacement of each of the plurality of tools relative to the workpiece in response to at least one of the control signals.

2. The assembly of claim 1 wherein, the second displacement mechanism is capable of a higher frequency response than the first displacement mechanism.

3. The assembly of claim 1, wherein the second displacement mechanisms are arranged in one or more groups.

4. The assembly of claim 3 wherein said second displacement mechanisms is supplied with at least one control signal, the control signal supplied to each second displacement mechanism is similar to the signal of other second displacement mechanisms in the group; and each control signal is temporally offset so that for each second displacement mechanism in the group the control signal as a function of work piece position is similar.

5. The assembly of claim 1, wherein each of the plurality of the second displacement mechanisms comprises actuators, the actuators comprising comprise piezoelectric actuators or voice coils.

6. The assembly of claim 1, wherein the first displacement mechanism is configured to displace the second displacement mechanisms in response to the control signals, in a first direction and in a second direction so as to define a number of discrete paths along the workpiece.

7. The assembly of claim 6, wherein the workpiece comprises a cylindrical drum, the first direction is along an angular displacement, θ, about an axis of the drum, and the second direction is along the axis of the drum.

8. The assembly of claim 6, wherein the workpiece comprises a substantially planar surface, and the first direction and the second direction are substantially orthogonal to each other.

9. The assembly of claim 6, wherein at least one of the discrete paths is annular.

10. The assembly of claim 6, wherein at least one of the discrete paths is helical paths.

11. The assembly of claim 1, further comprising:
a sensor unit arranged to detect a position of at least one of the second displacement mechanisms, said sensor unit providing a position signal indicative of a detected position of the second displacement mechanism to a controller; wherein the controller comprises a feedback control unit arranged to receive the position signal from the sensor unit and in response to the position signal the controller adjusts at least one of the plurality of control signals.

12. The assembly of claim 11, wherein the feedback control unit comprises:
an analog to digital converter unit arranged to receive the position signal from the sensor unit and convert the position signal to a digital position signal; and
a feedback controller circuit arranged to receive the digital position signal and adjust at least one of the plurality of control signals based on the digital position signal.

13. The assembly of claim 1, wherein at least one of the plurality of control signals is defined by a random or pseudo random function.

14. The assembly of claim 1 wherein at least one of the plurality of tools is a cutting tool.

15. The assembly of claim 14, further comprising means for displacing the cutting tool relative to the workpiece in the first set of coordinates, wherein the cutting tool is displaced in a first direction and a second direction so as to define a number of discrete paths along the workpiece.

16. The assembly of claim 9, further comprising means for displacing the second displacement mechanisms relative to the workpiece wherein said means comprises means for making at least two passes over each discrete path, each pass over a particular path being substantially identical in displacement of the second displacement mechanisms.

17. An assembly for modifying a surface of a workpiece, said assembly being responsive to a plurality of control signals, said assembly comprising:
a plurality of tools configured to modify the surface of the workpiece; and
a plurality of displacement mechanisms, each displacement mechanism arranged to displace a respective one of the tools along a substantially same path on the workpiece in response to at least one of the control signals.

18. The assembly of claim 17, wherein the control signals supplied to each displacement mechanism are similar to each other, and are temporally offset from each other.

19. The assembly of claim 17, wherein the plurality of displacement mechanisms are configured to support the tools arranged radially around a cylindrical workpiece along substantially the same axial position along the cylindrical workpiece.

20. The assembly of claim 17, where each of the plurality of displacement mechanisms comprises a first displacement mechanism configured to provide a first displacement in response to the control signals, and a second displacement mechanism configured to provide a second displacement in response to the control signals, wherein the first displacement mechanism supports the second displacement mechanism.

21. The assembly of claim 17, where the second displacement mechanisms are supported by a same first displacement mechanism.

22. The assembly of claim 21, wherein the second displacement mechanisms are configured to support the tools arranged radially around a cylindrical workpiece along substantially the same axial position along the cylindrical workpiece.

23. The assembly of claim 17, wherein each tool comprises at least one of a cutting tool or a material deposition tool.

24. The assembly of claim 23, wherein each tool comprises at least one of a single crystal diamond tool, diamond coated tool, laser engraving tool, high speed milling tool, fly cutting tool, or electrical discharge tool.

25. The assembly of claim 23, wherein each tool comprises a cutting tool, and the displacement mechanisms are arranged to displace the tools progressively deeper into the workpiece along the substantially same path in response to at least one of the control signals.

26. The assembly of claim 23, wherein each tool comprises a material deposition tool, and the displacement mechanisms are arranged to displace the tools progressively further away from the workpiece along the substantially same path in response to at least one of the control signals.

27. An assembly for modifying the surface of a workpiece, said assembly being responsive to a plurality of control signals, said assembly comprising:
a first group of tools configured to modify the surface of the workpiece;
a second group of tools configured to modify the surface of the workpiece;
a first group of displacement mechanisms, each displacement mechanism of the first group arranged to displace a respective one of the first group of tools along a substantially same first path on the workpiece in response to at least one of the control signals; and
a second group of displacement mechanisms, each displacement mechanism of the second group arranged to displace a respective one of the second group of tools along a substantially same second path on the workpiece in response to at least one of the control signals.

28. The assembly of claim 27, wherein the control signals supplied to each displacement mechanism in a group are similar to each other; and are temporally offset from each other.

29. The assembly of claim 27, wherein the first group of displacement mechanisms are configured to support the first group of tools arranged radially around a cylindrical workpiece along substantially a same first axial position along the cylindrical workpiece, and the second group of displacement mechanisms are configured to support the second group of tools arranged radially around the cylindrical workpiece along substantially a same second axial position along the cylindrical workpiece, where the first axial position is different from the second axial position.

30. The assembly of claim 27, where each of the first group of displacement mechanisms comprises a first displacement mechanism configured to provide a first displacement in response to the control signals, and a second displacement mechanism configured to provide a second displacement in response to the control signals, wherein the first displacement mechanism supports the second displacement mechanism, and the second displacement mechanisms are supported by a same first displacement mechanism.

31. The assembly of claim 30, wherein the second displacement mechanisms are configured to support the first group of tools arranged radially around a cylindrical workpiece along substantially the same axial position along the cylindrical workpiece.
